(19) United States
(12) Patent Application Publication
(10) Pub. No.: US 2026/0012636 A1
(43) Pub. Date: Jan. 8, 2026

(54) VIDEO SIGNAL PROCESSING METHOD USING LINEAR MODEL AND DEVICE THEREFOR

(71) Applicant: WILUS INSTITUTE OF STANDARDS AND TECHNOLOGY INC., Gyeonggi-do (KR)

(72) Inventors: Dongcheol KIM, Gyeonggi-do (KR); Kyungyong KIM, Gyeonggi-do (KR); Juhyung SON, Gyeonggi-do (KR); Jinsam KWAK, Gyeonggi-do (KR)

(21) Appl. No.: 18/881,722

(22) PCT Filed: Jul. 7, 2023
(86) PCT No.: PCT/KR2023/009711

§ 371 Date: Jan. 6, 2025

(30) Foreign Application Priority Data
Jul. 7, 2022 (KR) 10-2022-0084057
Jul. 13, 2022 (KR) 10-2022-0086574
Oct. 25, 2022 (KR) 10-2022-0138759

(51) Int. Cl. H04N 19/593; H04N 19/11; H04N 19/132; H04N 19/176; H04N 19/186; H04N 19/189

(52) U.S. Cl. CPC H04N 19/593; H04N 19/11; H04N 19/132; H04N 19/176; H04N 19/186; H04N 19/189

(57) ABSTRACT

A video signal decoding device comprises a processor, wherein the processor predicts a sample of a chroma component corresponding to a sample of a luma component of a current block on the basis of the sample of the luma component, and predicts the current block on the basis of a predicted value of the sample of the chroma component. The predicted value of the sample of the chroma component is obtained using a linear equation, and the linear equation may include a term for a gradient value of the sample of the luma component.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

An aspect of the present specification is to provide a video signal processing method and a device therefor to increase the coding efficiency of a video signal.

### Solution to Problem

The present specification provides a video signal processing method and a device therefore.

In the present specification, a video signal decoding device may include a processor, wherein the processor is configured to predict, based on a luma component sample of a current block, a chroma component sample corresponding to the luma component sample, and predict the current block based on a predicted value of the chroma component sample, wherein the predicted value of the chroma component sample is obtained using a linear equation, and the linear equation includes a term for a gradient value of the luma component sample.

In the present specification, a video signal encoding device may include a processor, wherein the processor is configured to obtain a bitstream that is decoded by a decoding method, the decoding method including: predicting, based on a luma component sample of a current block, a chroma component sample corresponding to the luma component sample; and predicting the current block based on a predicted value of the chroma component sample, wherein the predicted value of the chroma component sample is obtained using a linear equation, and the linear equation includes a term for a gradient value of the luma component sample.

In the present specification, in a computer-readable non-transitory storage medium for storing a bitstream, the bitstream may be decoded by a decoding method, and the decoding method may include: predicting, based on a luma component sample of a current block, a chroma component sample corresponding to the luma component sample; and predicting the current block based on a predicted value of the chroma component sample, wherein the predicted value of the chroma component sample is obtained using a linear equation, and the linear equation includes a term for a gradient value of the luma component sample.

The linear equation may include a term for a value of the luma component sample.

The linear equation may include a term for a value of a filter of a Sobel-based gradient pattern.

The linear equation may include a non-linear term.

The linear equation may include seven terms.

The linear equation may include a term for a median value of bitDepth.

The linear equation may include terms for values of neighboring luma component samples of the luma component sample.

The neighboring luma component samples may include a luma component sample adjacent to the top of the luma component sample, a luma component sample adjacent to the left of the luma component sample, a luma component sample adjacent to the right of the luma component sample, and a luma component sample adjacent to the bottom of the luma component sample.

The neighboring luma component samples may include a luma component sample adjacent to the left of the luma component sample and a luma component sample adjacent to the right of the luma component sample.

The neighboring luma component samples may include a luma component sample adjacent to the top of the luma component sample and a luma component sample adjacent to the bottom of the luma component sample.

The neighboring luma component samples may include a luma component sample adjacent to the top-left of the luma component sample and a luma component sample adjacent to the bottom-right of the luma component sample.

The neighboring luma component samples may include a luma component sample adjacent to the top-right of the luma component sample and a luma component sample adjacent to the bottom-left of the luma component sample.

The neighboring luma component samples may include a luma component sample adjacent to the top-left of the luma component sample, a luma component sample adjacent to the top-right of the luma component sample, a luma component sample adjacent to the bottom-left of the luma component sample, and a luma component sample adjacent to the bottom-right of the luma component sample.

### Advantageous Effects of Invention

The present disclosure provides a method for efficiently processing a video signal.

The effects obtainable from the present specification are not limited to the effects mentioned above, and other effects not mentioned may be clearly understood by to those skilled in the art, to which the present disclosure belongs, from the description below

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction

FIG. 8 illustrates the relationship between a luma sample and a chroma sample according to an embodiment of the present disclosure.

FIG. 9 illustrates a reference sample required for Cross-Component Linear Model (CCLM) prediction according to an embodiment of the present disclosure.

FIG. 10 illustrates modes to which a CCLM is applied according to an embodiment of the present disclosure.

FIG. 11 illustrates a CCLM mode using two linear models according to an embodiment of the present specification.

FIG. 12 illustrates the partition structure of a block according to an embodiment of the present disclosure.

FIG. 13 illustrates a method for optimizing a linear model for CCLM according to an embodiment of the present disclosure.

FIG. 14 illustrates a method for obtaining parameter values for an optimized linear model for CCLM according to an embodiment of the present disclosure.

FIG. 15 illustrates a gradient linear model (GLM) according to an embodiment of the present disclosure.

FIG. 16 illustrates a filter for obtaining gradient values used in a GLM.

FIGS. 17 and 18 illustrate syntax structures according to an embodiment of the present disclosure.

FIG. 19 illustrates samples for a CCCM.

FIG. 20 illustrates a pattern of a CCCM filter according to an embodiment of the present disclosure.

FIG. 21 illustrates a chroma component block and a luma component block corresponding to the chroma component block when a chroma format is 4:2:0 according to an embodiment of the present disclosure.

FIG. 22 illustrates a method for deriving filters corresponding to multiple CCCM filters based on a derived intra-prediction mode according to an embodiment of the present disclosure.

FIG. 23 illustrates a method for combining prediction samples of CCCM filters to generate a final chroma prediction sample according to an embodiment of the present disclosure.

FIG. 24 illustrates the type of transform kernel according to an embodiment of the present disclosure.

FIG. 25 illustrates a process of reconstructing a residual signal according to an embodiment of the present disclosure.

FIG. 26 illustrates a method for applying LFNST according to an embodiment of the present disclosure.

FIG. 27 illustrates a LFNST set for each intra-prediction mode according to an embodiment of the present disclosure.

FIG. 28 illustrates a method for obtaining a predicted value of a chroma sample according to an embodiment of the present disclosure.

### BEST MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

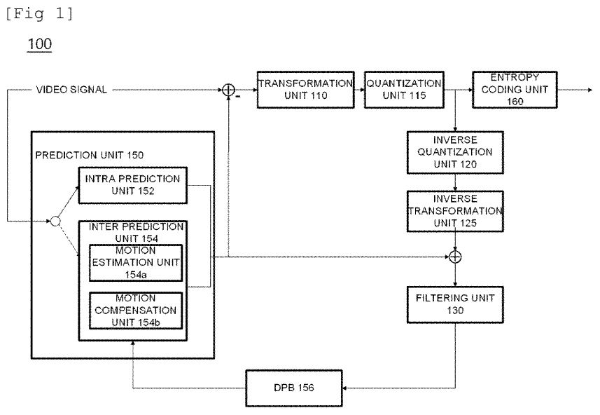

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2NX2N, an error signal may be present only in the first 2NXN block, and the transform process may be performed on the first 2NXN block. However, the second 2NXN block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

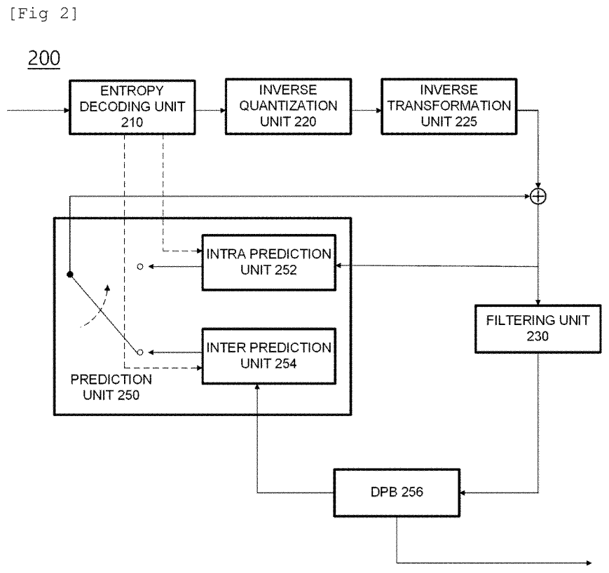

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

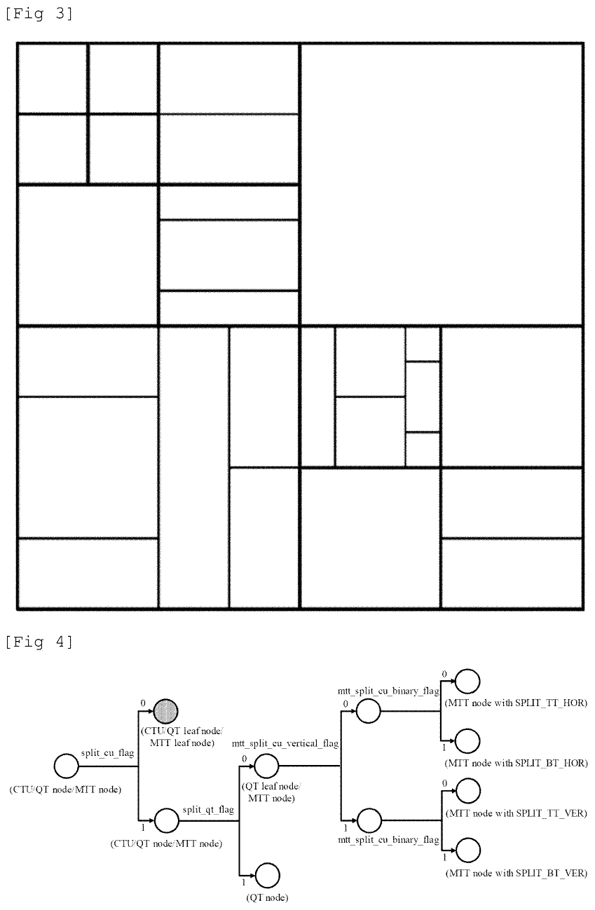

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2NX2N size in a quad tree structure may be split into four nodes having an NXN size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2NX2N size may be split into two NX2N nodes by vertical binary split, and split into two 2NXN nodes by horizontal binary split. In addition, in a ternary tree (TT) structure, a node of a 2NX2N size is split into (N/2) X2N, NX2N, and (N/2) X2N nodes by vertical ternary split, and split into 2NX (N/2), 2NXN, and 2NX (N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

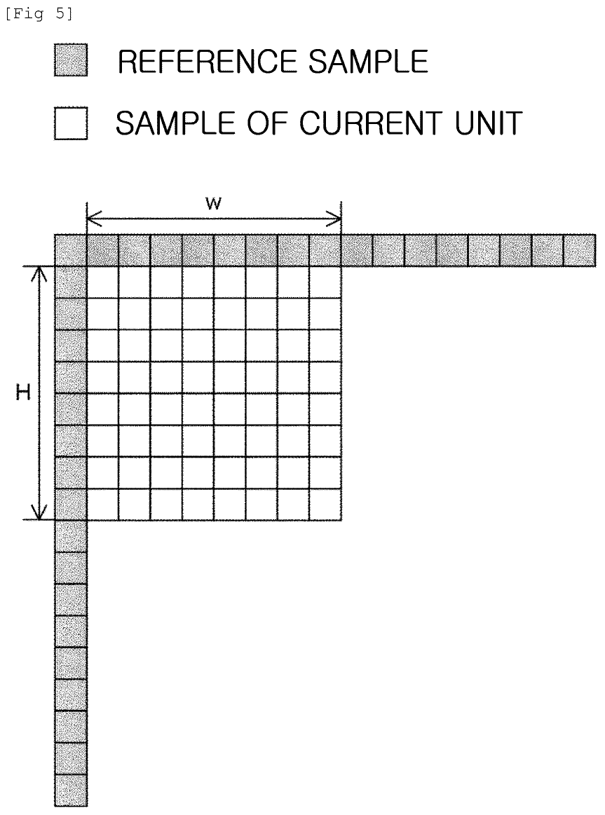

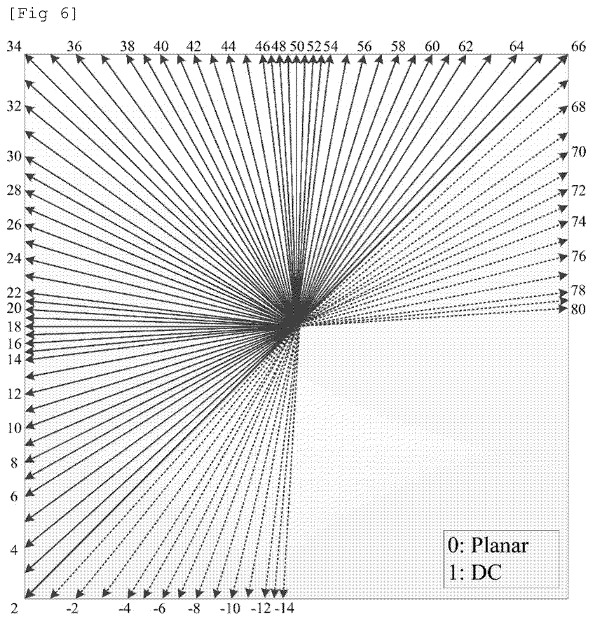

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is WXH and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than-135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, 1/4 pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, 1/4 pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

The motion candidate and the motion information candidate of this specification may have the same meaning. In addition, the motion candidate list and the motion information candidate list of this specification may have the same meaning.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

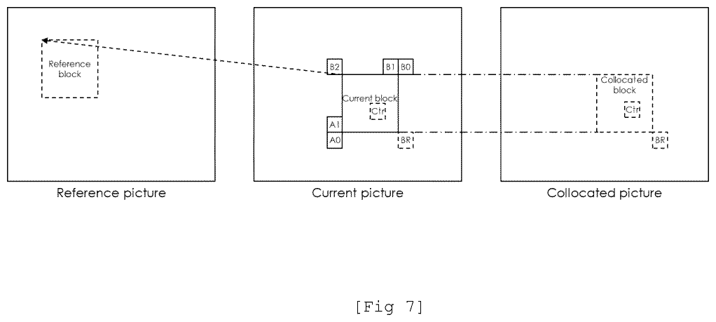

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

In the present specification, a block may be used interchangeably with a sample.

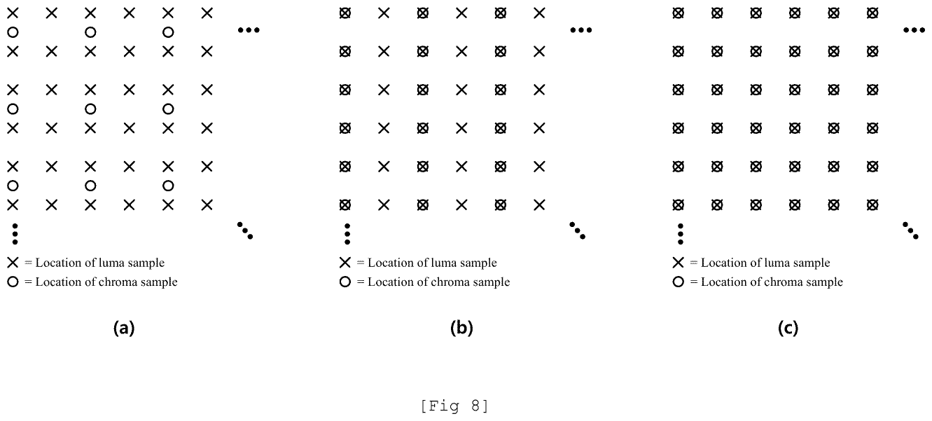

FIG. 8 illustrates the relationship between a luma sample and a chroma sample according to an embodiment of the present disclosure.

FIG. 8 illustrates the positional relationship between luma samples and chroma samples in the horizontal and vertical directions. Furthermore, FIG. 8 illustrates the ratio relationship between luma samples and chroma samples. In FIG. 8, X may refer to a luma sample and O may refer to a chroma sample.

FIG. 8A illustrates the locations of luma samples and chroma samples when the chroma format (the relationship between a luma sample and a chroma sample) is 4:2:0 (or 4:1:1). There may be one chroma sample (Cb, Cr) corresponding to every four luma samples. FIG. 8B illustrates the locations of luma samples and chroma samples when the chroma format is 4:2:2. There may be two chroma samples corresponding to every four luma samples. FIG. 8C illustrates the locations of luma samples and chroma samples when the chroma format is 4:4:4. There may be four chroma samples corresponding to every four luma samples. There may be four chroma samples corresponding to every four luma samples. For one luma sample, one chroma sample may be positioned at the same location.

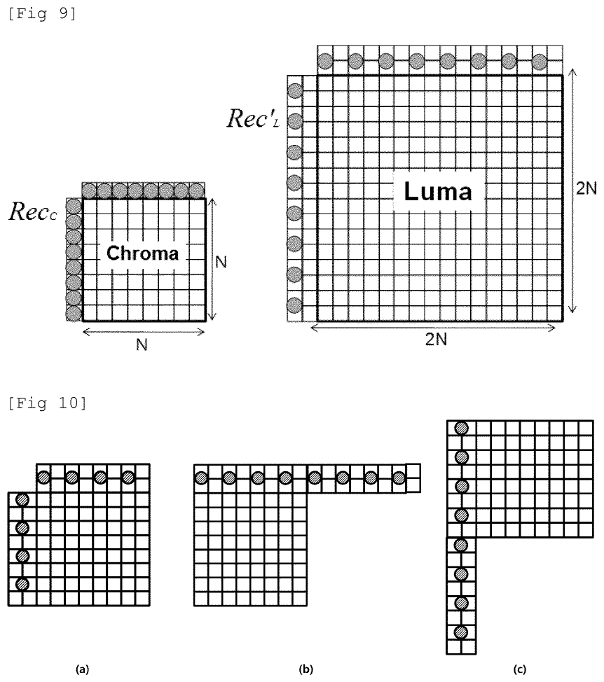

FIG. 9 illustrates a reference sample required for Cross-Component Linear Model (CCLM) prediction according to an embodiment of the present disclosure.

When there are a first color component and a second color component corresponding to a current block, the second color component may be predicted and/or reconstructed based on the first color component. In this case, a model of the relationship between the first color component and the second color component may be used. That is, the second color component may be predicted and/or reconstructed from the first color component, based on the model of the relationship between the first color component and the second color component. The model of the relationship between the first color component and the second color component may be modelled from a sample of the already reconstructed first color component and a sample of the already reconstructed second color component. In this case, the sample of the already reconstructed first color component and the sample of the already reconstructed second color component may be samples around the current block. Based on the model of the relationship between the first color component and the second color component, the second color component may be predicted and/or reconstructed using the already reconstructed first color component. In this case, the first color component may be a luma component and the second color component may be a chroma component. Furthermore, based on the decoding and encoding order, the first color component may be a chroma component and the second color component may be a luma component. Furthermore, the first color component and the second color component may be any one of Y, U, and V components. Furthermore, the first color component may refer to multiple color components.

For the chroma intra prediction, the CCLM prediction may be used. When the cross-component correlation present in the YUV 4:2:0 sequence is used, the compression performance of the video may be more efficient. To reduce cross-component redundancy, in CCLM prediction, chroma sample(s) of a current block may be predicted and/or reconstructed based on reconstructed luma sample(s) of the current block. In this case, a linear model to be described later may be used. The linear model in the present specification may be expressed as a linear equation, a linear mathematical expression, or the like.

$$predC ( i , j ) = α \cdot recL ( i , j ) + β \qquad [ Equation 1 ]$$

Equation 1 shows a linear model used to reconstruct a chroma sample based on an already reconstructed luma sample.

In Equation 1, predC(i,j) may be the predicted value of a chroma sample at location(i,j) of a current block, and recL(i,j) may be the value of an already reconstructed luma sample at location (i,j) of the current block. The top-left location of the current block may be (0, 0).

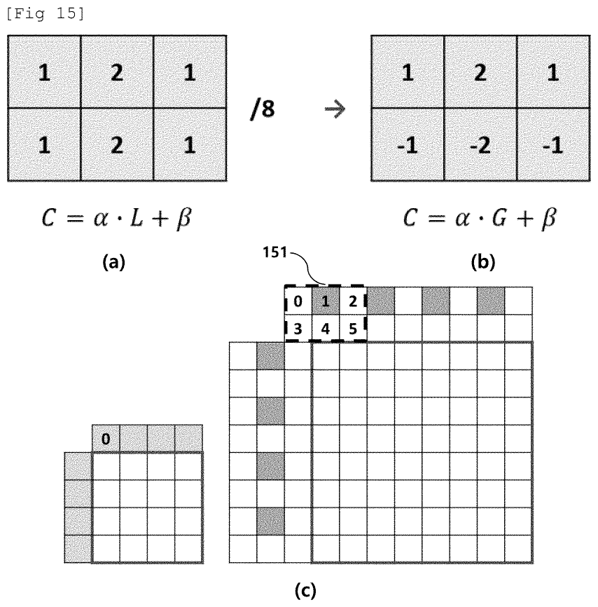

When the chroma sample density is smaller than the luma sample density (e.g., for a YUV 4:2:0 image), the already reconstructed luma sample may be a down-sampled luma sample. Down-sampling may refer to the process of matching the number of luma samples to the number of chroma samples when the number of luma samples and chroma samples is not 1:1, as shown in FIG. 8C. The value of the down-sampled luma samples may be obtained by performing a weighted average according to a 6-tap filter (see FIG. 15). The parameters a and B in Equation 1 may be values to minimize the regression error between the reconstructed luma sample (or down-sampled luma samples) and the chroma sample around the current block. The parameter a may be obtained based on Equation 2 and the parameter β may be obtained based on Equation 3.

$$α = \frac{N \cdot \sum ( L ( n ) \cdot C ( n ) ) - \sum L ( n ) \cdot \sum C ( n )}{N \cdot \sum ( L ( n ) \cdot L ( n ) ) - \sum L ( n ) \cdot \sum L ( n )} \qquad [ Equation 2 ]$$

$$β = \frac{\sum C ( n ) - α \cdot \sum L ( n )}{N} \qquad [ Equation 2 ]$$

In Equations 2 and 3, L(n) and C(n) may refer to reference samples of the CCLM. In addition, in the above equations, L(n) may refer to reconstructed luma samples used for modelling (e.g., the process of obtaining the parameters a and B), and C(n) may refer to reconstructed chroma samples used for modelling. When the number of luma samples and the number of chroma samples are different, the luma samples may be down-sampled and used. L(n) and C(n) may refer to surrounding (neighboring) samples of the current block. N may be the number of L(n) and C(n) pairs. Specifically, L(n) may refer to down-sampled and reconstructed luma samples at the top and left of the current block, C(n) may refer to chroma samples at the top and left of the current block, and N may represent twice the minimum value of the horizontal and vertical lengths of a coding block of a current chroma coding block. A video signal processing device (e.g., an encoder or a decoder) may down-sample non-square shaped compression blocks to ensure that neighboring samples with longer boundaries have the same value as samples with shorter boundaries. Equations 2 and 3 are merely examples of obtaining the parameters a and B. The parameters a and B may be obtained by methods other than Equations 2 and 3 described above.

FIG. 10 illustrates modes to which CCLM is applied according to an embodiment of the present disclosure.

The CCLM may be divided into various modes (FIG. 10A to FIG. 10C) based on three reference sample configuration methods. In this case, the CCLM may have modes which basically use one linear mode 1 (mode 1 to mode 3). Furthermore, the CCLM may have modes which use two linear models (mode 4 to mode 6). When the modes which use two linear models are included, the CCLM may be divided into six modes. Referring to FIG. 10A, reference samples for CCLM may be a reference block (a sample) above a current block and a reference block to the left of the current block. Referring to FIG. 10B, a reference sample for CCLM may be a reference block above a current block. Referring to FIG. 10C, a reference sample for CCLM may be a block to the left of a current block. A CCLM mode using a reference sample configured as in FIGS. 10A to 10C, one or two linear models may be used. Whether to use a CCLM mode (mode 1) using the reference sample according to FIG. 10A and using one linear model may be indicated by a syntax element included in a bitstream, wherein the syntax element may be represented by LM_CHROMA_IDX. Whether to use a CCLM mode (mode 2) using the reference sample according to FIG. 10B and using one linear model may be indicated by a syntax element included in a bitstream, wherein the syntax element may be represented by MDLM_T_IDX. Whether to use a CCLM mode (mode 3) using the reference sample according to FIG. 10C and using two linear models may be indicated by a syntax element included in a bitstream, wherein the syntax element may be represented by MDLM_L_IDX. Furthermore, whether to use a CCLM mode (mode 4) using the reference sample according to FIG. 10A and using two linear models may be indicated by a syntax element included in a bitstream, wherein the syntax element may be represented by MMLM_CHROMA_IDX.

Whether to use a CCLM mode (mode 5) using the reference sample according to FIG. 10B and using two linear models may be indicated by a syntax element included in a bitstream, wherein the syntax element may be represented by MMLM_T_IDX. Whether to use a CCLM mode (mode 6) using the reference sample according to FIG. 10C and using two linear models may be indicated by a syntax element included in a bitstream, wherein the syntax element may be represented by MMLM_L_IDX. When two linear models are used, each linear model may be a linear model for each of the two groups, when they are separated into two groups into which reference samples are divided based on the average value of (down-sampled) luma component reference sample values. When the chroma format is not 4:4:4 in the present specification, luma component reference samples for CCLM may be sample that has been down-sampled to achieve a 1:1 ratio between chroma samples and luma samples.

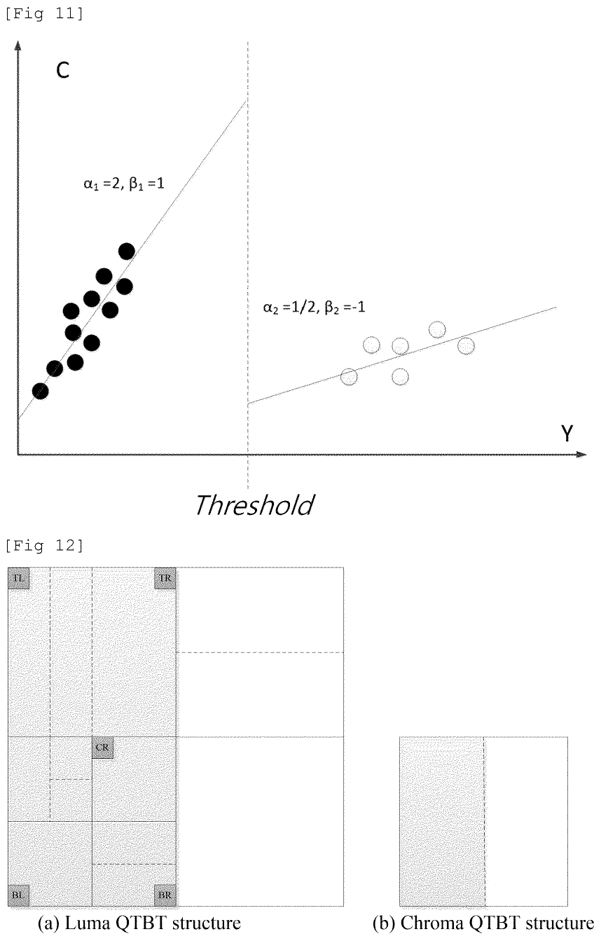

FIG. 11 illustrates a CCLM mode using two linear models according to an embodiment of the present disclosure.

The average value of reference samples (luma components or chroma components) for CCLM may be a threshold for obtaining a linear model. In this case, there may be one or more thresholds. Referring to FIG. 11, based on the threshold, the reference samples may be divided into multiple groups, and a video signal processing device may obtain a linear model according to each group. The threshold may also be applied to an already reconstructed luma component block of a current block. Equation 4, which is the linear model obtained based on the threshold, may be used to obtain predC(i,j) (predC(x,y)), which is the predicted value of a chroma block.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad [ Equation 4 ]$$

Referring to FIG. 11 and Equation 4, a first linear model may be obtained based on luma component reference samples having values below the average value, and a second linear model may be obtained based on luma component reference samples having values equal to or greater than the average value. In this case, the parameter α₁ of the first linear model may be 2 and the parameter β₁ may be 1. The parameter α₂ of the second linear model may be 1/2, and the parameter β₂ may be 1.

FIG. 12 illustrates the partition structure of a block according to an embodiment of the present disclosure.

FIG. 12A illustrates a QTBT partition structure of a luma component block in an I slice with YUV 4:2:0, and FIG. 12B illustrates a chroma QTBT partition structure in an I slice with YUV 4:2:0. A luma component block and a chroma component block may be partitioned into different structures depending on the partition form. When the partition form is a single tree, the luma component block and the chroma component block may be partitioned into the same structure. In this case, the chroma component block and the luma component block have a 1:1 correspondence. When the partition form is a separate tree, the luma component block and the chroma component block may be partitioned into different structures, as shown in FIG. 12. In this case, the chroma component block and the luma component block may not have a 1:1 correspondence. A chroma block (gray shaded portion) in FIG. 12B and a corresponding luma block (gray shaded portion) in FIG. 12A have different partition structures.

When using a luma component block to predict a chroma component block, a prediction mode of a luma component block stored at the top-left (TL) in FIG. 12A may be used when the partition form is a single tree, or a prediction mode of a luma component block stored at the center (CR) of the luma component block corresponding to the left block (the gray shaded portion) of a chroma component block in FIG. 12B may be used when the partition form is a separate tree.

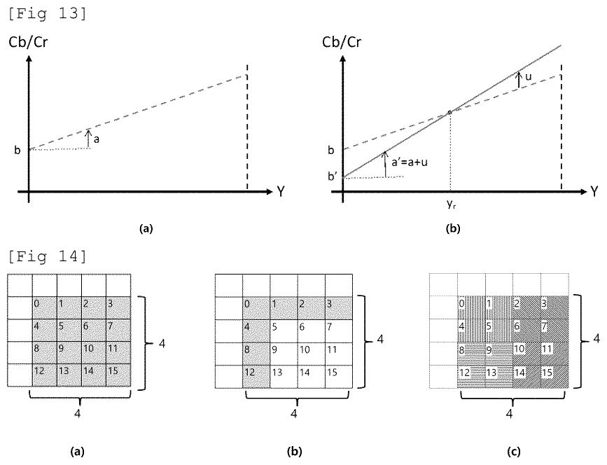

FIG. 13 illustrates a method for optimizing a linear model for CCLM according to an embodiment of the present disclosure.

FIG. 12A illustrates a and B in Equation 1 described above, and FIG. 12B illustrates α′ and β′ obtained to optimize a linear model. The α′ and β′ obtained to optimize the linear model may replace a and B in Equation 1, respectively, and the linear model may be as shown in Equation 5.

$$predC ( i , j ) = {α}^{′} \cdot recL ( i , j ) + {β}^{′} . \qquad [ Equation 5 ]$$

α′ may be obtained as α+u, and β′ may be obtained as β-u*yᵣ. Here, u is an integer value between −4 and 4, and may be a value signaled by a syntax element included in a bitstream. Also, the value of u may be a predetermined value. yᵣ may be the average value (or median value or the mode) of (down-sampled) luma component reference samples.

FIG. 14 illustrates a method for obtaining a parameter value of an optimized linear model for CCLM according to an embodiment of the present disclosure. FIG. 14 illustrates a method for obtaining yᵣ, which is the average value of luma component reference samples for obtaining a parameter value of an optimized linear model. Hereinafter, the method for obtaining yᵣ will be described. Referring to FIG. 14, a current block (a block indexed from 0 to 15) may be a block of size 4×4, and reference samples may be blocks (non-indexed blocks) adjacent the top and left of the current block.

i) Referring to FIG. 14A, when the size of a current block is 4×4 and the chroma format is 4:4:4, a video signal processing device may obtain yᵣ as an average value of all already reconstructed luma component samples (all reference samples in the current block, i.e., samples with indices 0 to 15) based on the similarity between the reference samples and the already reconstructed luma component samples.

ii) Referring to FIG. 14B, when the size of a current block is 4×4 and the chroma format is 4:4:4, the video signal processing device may obtain yᵣ as an average value of some of already reconstructed luma samples, based on the similarity between the reference samples to the reconstructed luma samples. In this case, some of the samples may be samples at predetermined locations. The samples at the predetermined locations may be samples at locations including the top boundary and the left boundary of the current block (i.e., samples with indices 0 to 4, 8, and 12).

iii) Referring to FIG. 14C, when the size of a current block is 4×4 and the chroma format is 4:4:4, based on the similarity between the reference samples and reconstructed luma samples, already reconstructed luma component samples may be classified into samples having a certain size based on the locations thereof, and the video signal processing device may obtain yᵣ as the average value of the classified samples. The samples may be categorized into samples with indices 0, 1, 4, and 5, samples with indices 2, 3, 6, and 7, samples with indices 8, 9, 12, and 13, and samples with indices 10, 11, 14, and 15.

The video signal processing device may obtain an average value (yᵣ) from i) to iii). Furthermore, the video signal processing device may obtain a new value by using the average value of yᵣ and the reference samples, and the new value may replace yᵣ. The average value of i) to iii) may be replaced by the median or the mode.

FIG. 15 illustrates a gradient linear model (GLM) according to an embodiment of the present disclosure.

FIG. 15A shows the weight values for a down-sampling filter used when the chroma format is not 4:4:4. As illustrated a diagram on the right side of FIG. 15C, the size of a current block may be 8×8, and the chroma format may be 4:2:0. A video signal processing device may multiply the values of six reference samples 151 located above a current coding block in FIG. 15C by filter weight values corresponding to the six values to obtain the average value thereof. In this case, down-sampled luma samples may be a left block in FIG. 15C. One chroma sample may be positioned at the location of each down-sampled luma sample, and the chroma samples and the luma samples may be in a 1:1 correspondence. By using the above-described method, the video signal processing device may obtain the down-sampled luma samples.

The following describes a method for obtaining a GLM based on the gradient value of a luma sample, and obtaining a predicted value (C(i,j)) of a chroma sample of the current block by using the GLM.

The GLM may be configured as Equation 6 or Equation 7 for each current block depending on a condition. The condition may be a condition based on a cost value.

$$C ( i , j ) = α \cdot G ( i , j ) + β \qquad [ Equation 6 ]$$

$$C ( i , j ) = α \cdot ( G ( i , j ) + {rec}^{′} L ( i , j ) ) + β \qquad [ Equation 7 ]$$

α and β in Equations 6 and 7 are equal to the value of the CCLM in Equation 1 described above, and G(i,j) may be gradient values corresponding to the already reconstructed luma samples. rec′L(i,j) may be the value of the down-sampled luma samples.

Equation 6 may be replaced by Equation 8, and Equation 7 may be replaced by Equation 9.

$$C ( i , j ) = {α}_{0} \cdot G ( i , j ) + {α}_{1} \cdot B + chromaMean \qquad [ Equation 8 ]$$

$$C ( i , j ) = {α}_{0} \cdot G ( i , j ) + {α}_{1} \cdot {rec}_{L}^{′} ( i , j ) + {α}_{2} \cdot midValue \qquad [ Equation 9 ]$$

B in Equation 8 may be the median value of content's bitdepth, and chromaMean may be the average value of chroma component reference samples. midValue in Equation 9 is the median value of content's bitdepth, and may be be 512 when bitdepth is 10-bit. In addition, midValue may be the average value of each chroma component reference sample, α_i in Equations 8 and 9 may be a coefficient corresponding to the value of an i-th already reconstructed down-sampled luma sample located around a chroma component sample to be predicted.

A filter for obtaining a gradient value may be described as a Sobel-based gradient pattern. There may be multiple filters for obtaining the gradient value. FIG. 15B illustrates one of the multiple filters for obtaining the gradient value. The GLM may be applied to chroma component Cb and Cr samples independently. In this case, whether the GLM is applied to each chroma component may be signaled by a syntax element (flag) included in a bitstream. Furthermore, when the GLM is applied to each chroma component sample, a syntax element indicating one of filters (multiple Sobel-based gradient patterns) for the GLM may be included in a bitstream and signaled. The syntax element indicating one filter may be described as a glm index.

The GLM may operate in the above-described six modes of CCLM or may be restricted to operate in a specific mode. In this case, the specific mode may be LM_CHROMA_IDX, MDLM_L_IDX, or MDLM_T_IDX. Furthermore, the GLM may not be applied to some of specific intra luma prediction modes. For example, the GLM may not be applied to all or some of a non-directional DC mode, a planar mode, etc. Also, when the intra luma prediction mode is one among: a non-directional DC mode, a planar mode, and an MIP mode, the GLM may not be applied. In this case, the value of a syntax element (flag) indicating whether the GLM is applied may be set to 0. Two linear models may also be used for the GLM. The following describes a GLM operation method and a GLM operation condition.

The condition for GLM to be applied are as follows.

$$( Condition ) Chroma Mode = MMLM\_CHROMA \_IDX ‖ Chroma Mode == MMLM\_L \_IDX ‖ Chroma Mode == MMLM\_T \_IDX ) \&\& ( Horizontal Size of Luma Block * Vertical Size of Luma Block >= Reference Value 1 ) .$$

The reference value 1 is a positive integer, and may be 16, 32, 64, 128, etc. In the above condition 1, the horizontal size of a luma block may be replaced by the horizontal size of a chroma block, and the vertical size of the luma block may be replaced by the vertical size of the chroma block. Furthermore, the reference value 1 is a value determined based on the chroma format, and may be 8, 16, 32, 64, 128, etc.

There may be multiple filters for obtaining the gradient value, and a glm index may be signaled to indicate one of multiple filters. The video signal processing device may parse the glm index included in a bitstream to determine a filter for obtaining the gradient value. In this case, there may be four, eight, or sixteen filters for obtaining the gradient value, and the glm index may indicate any one of the four, eight, or sixteen filters. The glm index may be signaled with a fixed bit size. Furthermore, to reduce signaling complexity, the glm index may be configured using a method to be described later rather than a fixed bit size.

i) The video signal processing device may re-sort, based on reference elements, filter candidates available as filters for obtaining the gradient value, and may signal/parse a glm index based on the re-sorted filter candidates. The reference elements may be luma prediction modes or coding modes (e.g., decoder side intra mode derivation (DIMD) or template-based intra mode derivation (TIMD)) of a current block. For example, the video signal processing device may classify luma prediction modes into multiple groups and re-sort filter candidates for obtaining a gradient value by using the most frequently used filter candidates in each group. Among the re-sorted candidates, the most frequently used candidate may be mapped to the lowest glm index, and the glm index may be signaled in a one-bit size. Based on the indices of the luma prediction modes, the luma prediction modes may be classified into multiple groups. In this case, the luma prediction modes may be classified into groups evenly (i.e., equal number per group) or unevenly (i.e., unequal number per group). The indices of the luma prediction modes included in each group may be consecutive. Furthermore, the luma prediction modes may be classified based on specific indices. For example, the luma prediction modes may be classified into luma prediction modes corresponding to indices equal to or fewer (or fewer than) specific indices and luma prediction modes corresponding to indices more than (or equal to or more than) the specific indices. In this case, there may be multiple specific indices. That is, the luma prediction modes may be classified into two groups when there is one specific index, the luma prediction modes may be classified into three groups when there are two specific indices, and the luma prediction modes may be classified into four groups when there are three specific indices. In this case, the specific index may be 18 (horizontal direction), 34 (diagonal direction), and 50 (vertical direction). In addition, non-directional prediction modes (e.g., a DC mode or a planar mode) may be classified as a separate group. The glm index may be signaled using a variable-length code scheme. The scheme may be a truncated unary binarization scheme. There is a problem that the amount of information increases when the value of the glm index increases. However, when the frequency of occurrence of a relatively low index is high, the glm index may be signaled with a small amount of information. Table 1 shows the structure of truncated unary binarization. Referring to Table 1, as the value of index (v) increases, the amount of information may also increase.

TABLE 1

| v | B_{tu, n} (v) |
|---|---|
| 0 | 0 |
| 1 | 1 0 |
| 2 | 1 1 0 |
| 3 | 1 1 1 0 |
| . | . |
| . | . |
| . | . |
| n − 2 | 1 1 1 1 . . . 1 0 |
| n − 1 | 1 1 1 1 . . . 1 1 |
| i_{bin} | 0 1 2 3 . . . n − 1 |

ii) The video signal processing device may calculate a cost value of each of filters for obtaining multiple gradient values, and may re-sort the filters based on the cost values. The video signal processing device may sort the filters in ascending order of the cost values corresponding to the filters. A filter with the smallest cost value may be mapped to the smallest glm index. The video signal processing device may signal/parse a glm index indicating any one of the re-sorted filters. The cost values may be calculated based on chroma component reference samples and chroma component prediction samples located at the boundary of a current block. The chroma component prediction samples located at the boundary of the current block may be samples positioned at specific locations.

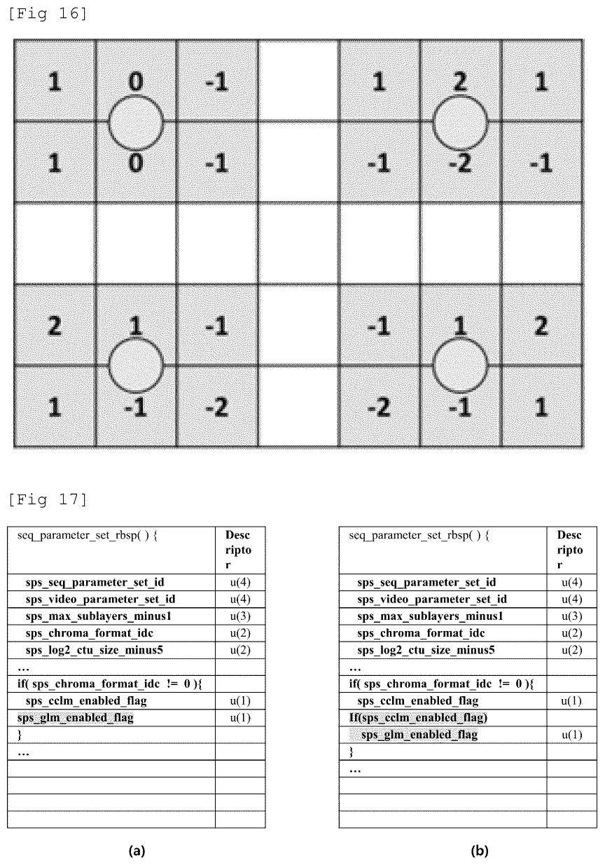

FIG. 16 illustrates a filter for obtaining a gradient value used in a GLM.

Specifically, FIG. 16 illustrates four Sobel-based gradient patterns that can be used in a GLM. A circle positioned at the center of each filter may be the result value of filtering.

Table 2 shows the filter values of 16 Sobel-based gradient patterns that can be used in a GLM.

TABLE 2

```
glmPattern[NUM_GLM_PATTERN][6]
=
{
  { 1, 0, −1,
      1, 0, −1, },
  { 1, 2, 1,
    −1, −2, −1, },
  { 2, 1, −1,
      1, −1, −2, },
  { −1, 1, 2,
    −2, −1, 1, },
#if NUM_GLM_PATTERN > 4
  { 0, 2, −2,
      0, 1, −1, },
  { 1, 1, 1,
    −1, −1, −1, },
  { 1, 1, −1,
      1, −1, −1, },
  { −1, 1, 1,
    −1, −1, 1, },
#if NUM_GLM_PATTERN > 8
  { 0, 1, −1,
      0, 1, −1, },
  { 0, 1, 1,
      0, −1, −1, },
  { 1, 1, 0,
      0, −1, −1, },
  { 0, 1, 1,
    −1, −1, 0, },
  { 1, −1, 0,
      1, −1, 0, },
  { 1, 1, 0,
    −1, −1, 0, },
  { 1, 2, 0,
      0, −2, −1, },
  { 0, 2, 1,
    −1, −2, 0, },
#endif
#endif
};
```

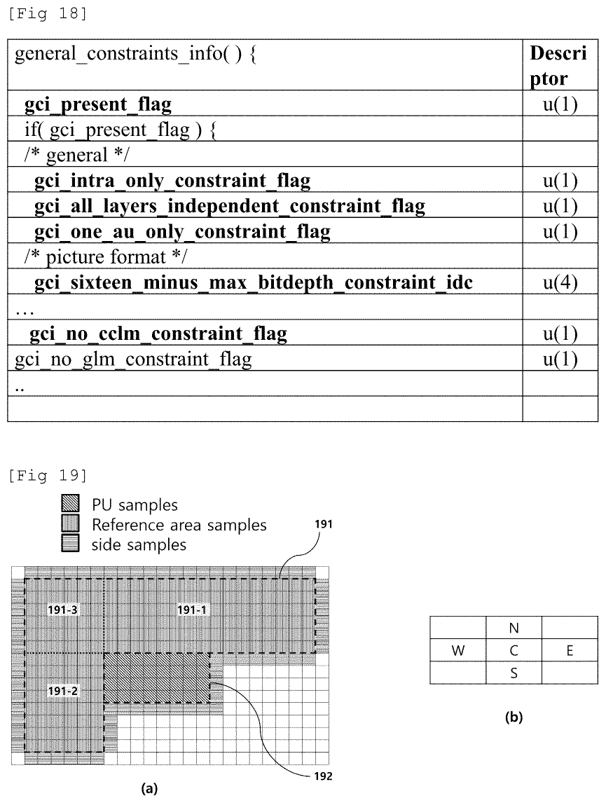

FIGS. 17 and 18 illustrate syntax structures according to an embodiment of the present disclosure.

Specifically, FIG. 17 illustrates a GLM-related syntax element (flag) included in a sequence parameter set RBSP. In FIG. 17, the GLM-related syntax element may be sps_glm_enabled_flag.

sps_glm_enabled_flag may indicate whether gradient linear model intra prediction is enabled. When the value of sps_glm_enabled_flag is 1, this indicates that the gradient linear model intra prediction from a luma component to chroma component is enabled for a coded layer video sequence (CLVS). When the value of sps_glm_enabled_flag is 0, this indicates that the gradient linear model intra prediction from a luma component to a chroma component is not enabled for the coded layer video sequence (CLVS). When sps_glm_enabled_flag is not present, the value of sps_glm_enabled_flag is inferred to be 0 (sps_glm_enabled_flag equal to 1 specifies that the gradient linear model intra prediction from luma component to chroma component is enabled for the CLVS. sps_glm_enabled_flag equal to 0 specifies that the glm intra prediction from luma component to chroma component is disabled for the CLVS. When sps_glm_enabled_flag is not present, it is inferred to be equal to 0).

The sequence parameter set RBSP may include a convolutional cross-component intra-prediction model (CCCM)-related syntax element. In FIG. 17, the CCCM-related syntax element may be sps_cccm_enabled_flag.

sps_cccm_enabled_flag may indicate whether a CCCM is enabled. When the value of sps_cccm_enabled_flag is 1, this indicates that a CCCM from a luma component to a chroma component is enabled for the CLVS. When the value of sps_cccm_enabled_flag is 0, this indicates that a CCCM from a luma component to a chroma component is not enabled for the CLVS. When there is no sps_cccm_enabled_flag, the value of sps_cccm_enabled_flag may be inferred to be 0 (sps_cccm_enabled_flag equal to 1 specifies that the convolutional cross-component intra-prediction model from luma component to chroma component is enabled for the CLVS. sps_cccm_enabled_flag equal to 0 specifies that the cccm intra-prediction model from luma component to chroma component is disabled for the CLVS. When sps_cccm_enabled_flag is not present, it is inferred to be equal to 0).

Hereinafter, a method for signaling/parsing sps_glm_enabled_flag will be described with reference to FIG. 17

Referring to FIG. 17A, sps_glm_enabled_flag may be parsed when the value of sps_chroma_format_idc is not 0. The sps_chroma_format_idc is a syntax element indicating the chroma format, and sps_chroma_format_idc equal to 0 may indicate that the chroma format is monochrome. In other words, when the chroma format is not monochrome, the sps_glm_enabled_flag may be parsed. Referring to FIG. 17B, when the value of sps_chroma_format_idc is not 0 and when the value of sps_cclm_enabled_flag is 1 (i.e., true), the sps_glm_enabled_flag may be parsed. That is, when the chroma format is not monochrome and when a CCLM is enabled, sps_glm_enabled_flag may be parsed.

According to FIG. 17A, a CCLM and a GLM may operate independently, and according to FIG. 17B, a GLM may be used as a means that is complementary to a CCLM. sps_cccm_enabled_flag may also be parsed according to the conditions described with reference to FIGS. 17A and 17B.

FIG. 18 illustrates a general_constraint_info( ) syntax structure. Referring to FIG. 18, the general_constraint_info( ) syntax structure may include a glm-related constraint syntax element (a constraint flag). The general_constraint_info( ) syntax structure may be called from a profile_tier_level( ) syntax structure. The profile_tier_level( ) syntax structure may be called from sequence parameter set RBSP syntax, video parameter set RBSP syntax, and decoding capability information RBSP syntax. The syntax elements included in the general_constraint_info( ) syntax structure may constrain syntax elements included in the sequence parameter set RBSP. The glm-related constraint syntax element may be no_gci_glm_constraint_flag.

no_gci_glm_constraint_flag may be a syntax element that constrains the value of sps_glm_enabled_flag. When the value of no_gci_glm_constraint_flag is 1, the value of sps_glm_enabled_flag for all pictures in OlsScope may be constrained to 0. That is, when the value of no_gci_glm_constraint_flag is 1, the gradient linear model intra prediction from a luma component to a chroma component may be constrained to be disabled for the CLVS. When the value of no_gci_glm_constraint_flag is 0, the value of sps_glm_enabled_flag may not be constrained (no_gci_glm_constraint_flag equal to 1 specifies that sps_glm_enabled_flag for all pictures in OlsInScope shall be equal to 0. gci_no_glm_constraint_flag equal to 0 does not impose such a constraint).

The general_constraint_info( ) syntax structure may include a CCCM-related constraint syntax element. The CCCM-related constraint syntax element may be no_gci_cccm_constraint_flag.

no_gci_cccm_constraint_flag may be a syntax element that constrains the value of sps_cccm_enabled_flag. When the value of no_gci_cccm_constraint_flag is 1, the value of sps_cccm_enabled_flag for all pictures in the OlsScope may be constrained to 0. That is, when the value of no_gci_cccm_constraint_flag is 1, a CCCM from a luma component to a chroma component may be constrained to be disabled for the CLVS. When the value of no_gci_cccm_constraint_flag is 0, the value of sps_cccm_enabled_flag may not be constrained (no_gci_cccm_constraint_flag equal to 1 specifies that sps_cccm_enabled_flag for all pictures in OlsInScope shall be equal to 0. gci_no_cccm_constraint_flag equal to 0 does not impose such a constraint).

FIG. 19 illustrates samples for a CCCM.

The CCCM may be one of methods for obtaining a value of a chroma component sample of a current block, and may be a method for predicting the chroma sample by using a luma component sample corresponding to the chroma sample and a neighboring luma component sample of the luma component sample according to various types of filters. That is, a video signal processing device may use a luma component sample of a current block to predict a chroma component sample corresponding to the luma component sample. The video signal processing device may reconstruct the current block by using the value of the predicted chroma component sample.

FIG. 19A illustrates the locations of reference samples (vertical hatching) 191 for applying the CCCM to a current prediction block (diagonal hatching) 192 and side samples (horizontal hatching) required when a cross-shaped filter is applied according to an embodiment of the present disclosure. When the size of the current prediction block 192 is M (width)×N (height) and when the number of luma component samples and the number of chroma component samples is in a 1:1 ratio, the reference samples 191 may include a reference sample area 191-1 with a size of 2M×6 in the above six rows which is twice the width of the current prediction block 192, a reference sample area 191-2 with a size of 6×2N in the left six rows which is twice the height of the current prediction block 192, and a reference sample area 191-3 with a size of 6×6 on the top-left of the current prediction block 192. That is, when the coordinates of the top-left sample of the current prediction block 192 is (0, 0), 191-1 may be (X1, Y1), 191-2 may be (X2, Y2), and 191-3 may be (X3, Y3). Here, X1 may be a value from 0 to 2M−1, Y1 may be a value from −1 to −6, X2 may be a value from −1 to −6, Y2 may be a value from 0 to 2N−1, and X3 and Y3 may be a value from −1 to −6.

FIG. 19B illustrates a sample of a cross-shaped pattern according to an embodiment of the present disclosure. In the present specification, a sample of any shape pattern may be represented by a sample filter. When a sample filter of the cross-shaped pattern in FIG. 19B is used for CCCM, an area to which the filter is applied may fall outside a reference sample area. When the area to which the filter is applied falls outside the reference sample area, additional required samples may be side samples. When the cross-shaped sample filter is applied based on the location of a C sample in FIG. 19B, an area other than the reference sample may be required. In this case, when the area other than the reference sample is not available, the value of the area other than the reference sample may be padded with the value of the C sample and used. In FIG. 19B, the C sample is a luma sample corresponding to a chroma component (Cb, Cr) sample, and N, E, S, and W samples may be samples positioned locations adjacent to the top, right, bottom, and left of the C sample, respectively. CCCM may be applied to each of chroma components (i.e., a Cb component and Cr component).

When a sample filter of a cross-shaped pattern for CCCM is applied, the predicted value (predChromaVal) of a chroma component sample may be calculated as shown in Equation 10.

$$predChromaVal = {c}_{0} C + {c}_{1} N + {c}_{2} S + {c}_{3} E + {c}_{4} W + {c}_{5} P + {c}_{6} B \qquad [ Equation 10 ]$$

The P value in Equation 10 is a nonlinear term, and may be calculated as (C*C+midVal)>>bitDepth. Here, midValue may be the median value of the content bitdepth, or may be the average value of each chroma component. bitDepth may refer to the bit depth. In content with a bitDepth of 10 bits, the P value may be calculated as (C*C+512)>>10. The B value, which is a bias term, may refer to an integer offset value, and may be the median value of the bitDepth content. For 10-bit content, the B value may be 512. In addition, the B value may be the average value of chroma component reference samples. Furthermore, the B value may be the difference (in absolute value) between the average value of luma component reference samples and the average value of chroma component reference samples. C, N, S, E, and W may refer to the values of samples according to the locations in FIG. 19B. The coefficients (C0, C1, . . . , C6) in Equation 10 may be values that minimize the mean square error (MSE) value of an autocorrelation matrix for luma component sample values of the reference sample area and a cross-correlation vector for chroma component sample values. The autocorrelation matrix may be obtained using LDL decomposition or Cholesky decomposition. Furthermore, the coefficients (C0, C1, . . . , C6) in Equation 10 may be obtained using back-substitution.

C, N, S, E, W, and P in Equation 10 may be replaced by C′, N′, S′, E′, W′, and P′, respectively. C′, N′, S′, E′, W′, and P′ may be calculated as follows.

$${C}^{′} = C - meanY , {N}^{′} = N - meanY , {S}^{′} = S - meanY , {E}^{′} = E - meanY , {W}^{′} = W - meanY , {P}^{′} = P - meanNonlinY$$

meanY may be the average value of the luma component reference samples. meanNonlinY may be calculated as follows.

$$meanNonlinY = ( meanY * meanY ) >> bitdepth or meanNonlinY = ( meanY * meanY + bitdepth >> 1 ) >> bitdepth$$

Equation 10 may be changed as shown in Equation 11.

$$predChromaVal = c 0 {C}^{′} + c 1 {N}^{′} + c 2 {S}^{′} + c 3 {E}^{′} + c 4 {W}^{′} + c 5 {P}^{′} + c 6 {B}^{′} + meanChroma \qquad [ Equation 11 ]$$

Equation 11 may have a form in which C, N, S, E, W, P, and B in Equation 10 are replaced by C′, N'S′, E′, W′, P′, and B′ and meanChroma is added. Here, meanChroma may be the average value of the chroma component reference samples. B′ in Equation 11 may be the difference (in absolute value) between the average value of the luma component reference samples and the average value of the chroma component reference samples.

Equation 11 may be modified depending on the luma samples used for CCCM. For example, when only C, N, S, and E among C, N, S, E, and W are used, Equation 11 may be modified to a form in which the term (c4 W′) corresponding to W is excluded. Also, Equation 11 may be modified to a form in which B′ is excluded.

Furthermore, C′, N′, S′, E′, and W′ in Equation 11 may be result values according to any one pattern (filter) among multiple Sobel-based gradient patterns. That is, C′, N′, S′, E′, and W′ in Equation 11 may be replaced by gradient values.

In addition, the P value in Equation 10 may be changed as follows.

i) The P value may be obtained according to (Cg*Cg+midVal)>>bitDepth. Cg may be the gradient value of a sample at location C in FIG. 19B. midVal may be the median value of bitDepth, and for content with a bitDepth of 10 bits, midVal may be 512. ii) The P value may be the average value of the gradient values of reference samples. iii) The P value may be the average value of gradient values at locations (C, N, E, S, and W) in FIG. 19B. iv) The P value may be obtained according to (meanG*meanG+bitDepth>>1)>>bitdepth. meanG may be the average value of the gradient values of reference samples.

The following describes a down-sampling process for matching the number of chroma samples to the number of luma samples in a 1:1 ratio when the chroma format is 4:2:2.

As described with reference to FIG. 15, in order to achieve the same number of luma samples as the number of chroma samples, the luma samples may be transformed by applying a down-sampling filter (FIG. 15A).

Equation 12 is a filter-base linear model (FLM) used for down-sampling.

$$C = {\sum }_{i = 0}^{N - 1} {α}_{i} \cdot {L}_{i} + β \qquad [ Equation 12 ]$$

In Equation 12, C is the value of a chroma component sample to be predicted, Lᵢ is the value of an i-th reconstructed down-sampled luma component sample located around the chroma component sample to be predicted, and αᵢ is a coefficient value corresponding to Lᵢ, and may be obtained using the above-described method for obtaining the coefficients (C0, C1, . . . , C6) in Equation 10. β may be an offset, and N may be the number of luma component samples required to calculate the value of the chroma component sample to be predicted. The value of N may be an integer between 2 and 6, and may be 2 or 6. In Equation 12, the values may be replaced by a gradient value, which is a resulting value for any one of multiple Sobel-based gradient patterns.

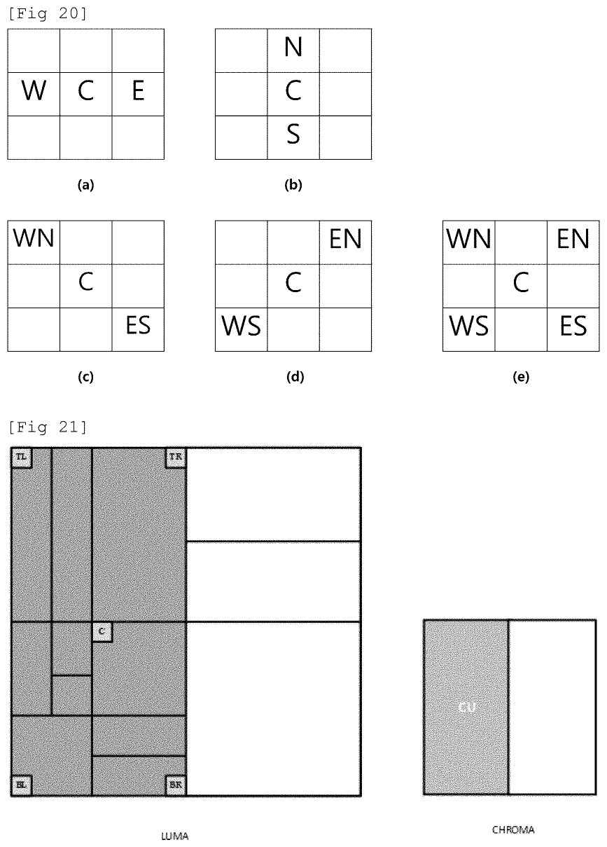

FIG. 20 illustrates a pattern of a CCCM filter according to an embodiment of the present disclosure.

Samples for a CCCM may be samples of patterns in FIGS. 20A to 20E in addition to the sample of the pattern in FIG. 19B. That is, filters for the CCCM may further include sample filters of the patterns in FIGS. 20A to 20E in addition to the sample filter of the pattern in FIG. 19B. Hereinafter, relationship equations for obtaining a predicted value (predChromaVal) of a chroma component sample according to each pattern will be described.

FIG. 20A shows a sample filter of a horizontal pattern. The relationship equation for the horizontal pattern may be predChromaVal32 c0C+c1 W+c2E+c3P(C)+c4P (W)+c5P (E)+c6B.

FIG. 20B shows a sample filter of a vertical pattern. The relationship equation for the vertical pattern may be predChromaVal=c0C+c1N+c2S+c3P(C)+c4P (N)+c5P(S)+c6B.

FIG. 20C shows a sample filter of a diagonal pattern. The relationship equation for the diagonal pattern may be predChroma Val=c0C+c1WN+c2ES+c3P(C)+c4P (WN)+c5P(ES)+c6B.

FIG. 20D shows a sample filter of a reverse diagonal pattern. The relationship equation for the reverse diagonal pattern may be predChroma Val=c0C+c1WS+c2EN+c3P(C)+c4P(ES)+c5P (EN)+c6B.

FIG. 20E shows a sample filter of an X-shaped pattern. The relationship equation for the vertical pattern may be predChromaVal=c0C+c1WN+c2ES+c3EN+c4WS+c5P(C)+c6B.

In P (a) used in the above relationship equations, a may be represented by an input value. The P value may be obtained based on the input value (a). The B value may be equal to the B value in Equation 10 or the B′ value in Equation 11. The P value is a nonlinear term and may be obtained as follows.

P=(input value*input value+midVal)>>bitDepth, wherein for 10-bit content, the value of midVal may be 512. In addition, P=(input value*input value +512)>>10.

Each pattern of a CCCM filter may be determined (derived) based on the intra-prediction mode of a luma block corresponding to a chroma component sample to be predicted without separate signaling.

FIG. 21 illustrates a chroma component block and a luma component block corresponding to the chroma component block when the chroma format is 4:2:0 according to an embodiment of the present disclosure.

Specifically, FIG. 21 illustrates a partition structure of a luma component block and a partition structure of a chroma component block when the chroma format is 4:2:0.

When the chroma format is 4:2:2, the vertical size ratio between the luma component block and the chroma component block may be 1:1 and the horizontal size ratio may be 2:1. When the chroma format is 4:4:4, the size ratio between the chroma component block and the luma component block may be 1:1.

A luma component block corresponding to the left CU of the chroma component block in FIG. 21 may be a block including vertices TL, TR, BL, and BR. The CCCM described above may be applied to the chroma component block in FIG. 21. A video signal processing device may use the chroma component block to derive an intra-prediction mode at a predetermined location of the luma component block corresponding to the chroma component block. When there is no information about the intra-prediction mode at the predetermined location, the predetermined intra-prediction mode may be set. In this case, the predetermined intra-prediction mode may be a planar mode or a DC mode. In addition, the intra-prediction mode of the chroma component block may be derived by a DIMD method using the neighboring samples of the chroma component block.

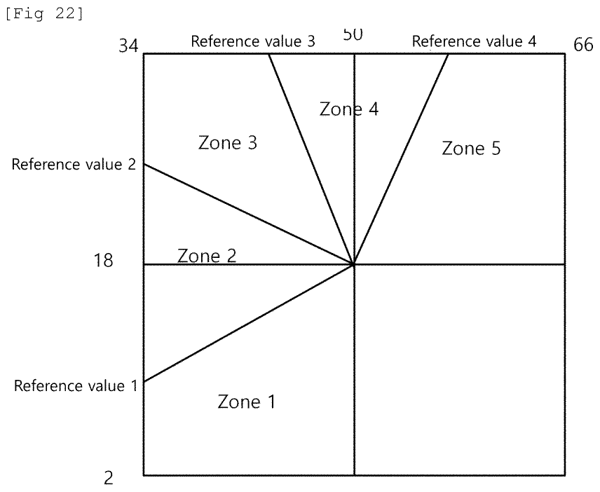

FIG. 22 illustrates a method for deriving filters corresponding to multiple CCCM filters based on a derived intra-prediction mode according to an embodiment of the present disclosure.

Referring to FIG. 22, intra-prediction modes may be classified into zones (Zone 1 to Zone 5) which are distinguished by reference values. That is, to the intra-prediction modes corresponding to the zones distinguished by the reference values, sample filters of corresponding patterns may be applied. Zone 1 may correspond to intra-prediction modes with indices less than or equal to reference value 1, Zone 2 may correspond to intra-prediction modes with indices greater than reference value 1 and less than or equal to reference value 2, Zone 3 may correspond to intra-prediction modes with indices greater than reference value 2 and less than or equal to reference value 3, Zone 4 may correspond to intra-prediction modes with indices greater than reference value 3 and less than or equal to reference value 4, and Zone 5 may correspond to intra-prediction modes with indices greater than reference value 4. Zones to which a planar mode, a DC mode, and an intra-prediction mode belong may be mapped (correspond) one-to-one to multiple CCCM sample filters. The following describes the one-to-one mapping (correspondence) relationship. The mapping relationship between intra-prediction modes and CCCM sample filters may be established by various methods without being limited to Mapping 1 to Mapping 5 described below.

(Mapping 1) i) A filter corresponding to the PLANAR mode may be a sample filter of a cross-shaped pattern. ii) A filter corresponding to the DC mode may be a sample filter of an X-shaped pattern. iii) A filter corresponding to Zone 1 may be a sample filter of a reverse diagonal pattern. iv) A filter corresponding to Zone 2 may be a sample filter of a horizontal pattern. v) A filter corresponding to Zone 3 may be a sample filter of a diagonal pattern. vi) A filter corresponding to Zone 4 may be a sample filter of a vertical pattern. vii) A filter corresponding to Zone 5 may be a sample filter of a diagonal pattern.

(Mapping 2) i) Filters corresponding to the PLANAR mode and the DC mode may be sample filters of a cross-shaped pattern. ii) A filter corresponding to Zone1 may be a sample filter of a reverse diagonal pattern. iii) A filter corresponding to the wideAngle mode of Zone 1 may be a sample filter of an X-shaped pattern. iv) A filter corresponding to Zone 2 may be a sample filter of a horizontal pattern. v) A filter corresponding to Zone 3 may be a sample filter of a diagonal pattern. vi) A filter corresponding to Zone 4 may be a sample filter of a vertical pattern. vii) A filter corresponding to Zone 5 may be a sample filter of a diagonal pattern. viii) A filter corresponding to the wideAngle mode of Zone 5 may be a sample filter of an X-shaped pattern.

(Mapping 3) i) Filters corresponding to PLANAR mode and the DC mode may be sample filters with an X-shaped pattern. ii) A filter corresponding to Zone 1 may be a sample filter of a reverse diagonal pattern. iii) A filter corresponding to the wideAngle mode of Zone 1 may be a sample filter of a cross-shaped pattern. iv) A filter corresponding to Zone 2 may be a sample filter of a horizontal pattern. v) A filter corresponding to Zone 3 may be a sample filter of a diagonal pattern. vi) A filter corresponding to Zone 4 may be a sample filter of a vertical pattern. vii) A filter corresponding to Zone 5 may be a sample filter of a diagonal pattern. viii) A filter corresponding to the wideAngle mode of Zone 5 may be a sample filter of a cross-shaped pattern.

(Mapping 4) i) Filters corresponding to the PLANAR mode and the DC mode may be sample filters with a cross-shaped pattern. ii) A filter corresponding to Zone 1 may be a sample filter of a reverse diagonal pattern. iii) A filter corresponding to Zone 2 may be a sample filter of a horizontal pattern. iv) A filter corresponding to Zone 3 may be a sample filter of a diagonal shape pattern. v) A filter corresponding to Zone 4 may be a sample filter of a vertical pattern. vi) A filter corresponding to Zone 5 may be a sample filter of a diagonal pattern.

(Mapping 5) i) Filters corresponding to the PLANAR mode and the DC mode may be sample filters with an X-shaped pattern. ii) A filter corresponding to Zone 1 may be a sample filter of a reverse diagonal pattern. iii) A filter corresponding to Zone 2 may be a sample filter of a horizontal pattern. iv) A filter corresponding to Zone 3 may be a sample filter of a diagonal pattern. v) A filter corresponding to Zone 4 may be a sample filter of a vertical pattern. vi) A filter corresponding to Zone 5 may be a sample filter of a diagonal pattern.

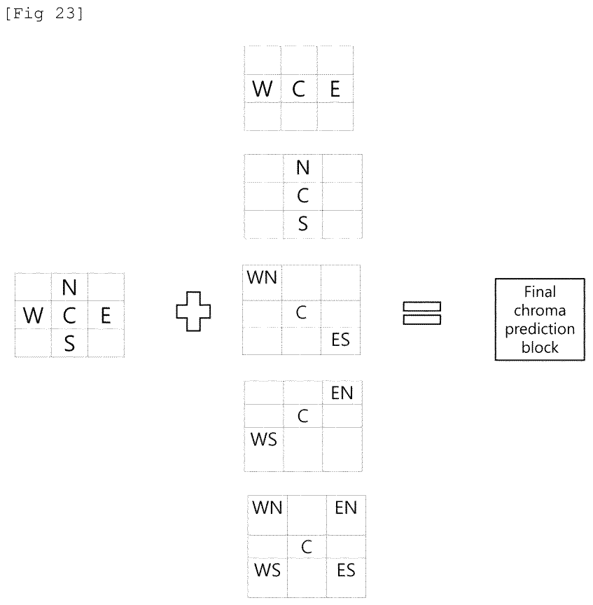

FIG. 23 illustrates a method for combining prediction samples of CCCM filters to generate a final chroma prediction sample, according to an embodiment of the present disclosure.

Referring to FIG. 23, a chroma prediction sample may be obtained using two sample filters. That is, a video signal processing device may obtain a final chroma prediction sample by using some of the sample filters of the six patterns described above. Hereinafter, a method in which the video signal processing device obtains the final chroma prediction sample by using two of the sample filters of the six patterns will be described with reference to FIG. 23.

The video signal processing device may obtain a final chroma prediction sample by combining a chroma prediction sample, obtained using a sample filter of the cross-shaped pattern, with a chroma prediction sample obtained using any one of the five sample filters described with reference to FIG. 20. In this case, the final chroma prediction sample may be obtained via Equation 13 or Equation 14. That is, the video signal processing device may obtain the final chroma prediction sample by combining a first chroma prediction sample, obtained using a first sample filter, with a second chroma prediction sample, obtained using a second sample filter, and may predict (reconstruct) a current block based on the final chroma prediction sample.

$$C = W 0 ⋆ A + ( 1 - W 0 ) ⋆ B \qquad [ Equation 13 ]$$

$$C = ( W 0 ⋆ A + W 1 * B + ( 1 << ( shift - 1 ) ) ) >> shift \qquad [ Equation 14 ]$$

In Equations 13 and 14, A may be the value of the first chroma prediction sample obtained by the first sample filter, B may be the value of the second chroma prediction sample obtained by the second sample filter, W0 may be the combination ratio, and C may be the value of the final chroma prediction sample. In Equation 13, W0 is a value greater than or equal to 0 and less than or equal to 1, or greater than or equal to −1 and less than or equal to 0, and may be 0, 0.1, 0.2, . . . , 1, or −1, −0.9, −0.8, . . . , 0. In Equation 14, the shift value may be 2, and W0 may be a first combination ratio of the first sample filter, and W1 may be a second combination ratio of the second sample filter. In this case, (W0, W1) may be (1, 3), (3, 1), or (2, 2). In Equations 13 and 14, the first sample filter may be a sample filter of a cross-shaped pattern, and the second sample filter may be any of the five sample filters described with reference to FIG. 20. Conversely, the first sample filter may be any one of the five sample filters described with reference to FIG. 20, and the second sample filter may be a sample filter of a cross-shaped pattern.

In Equations 13 and 14, two filters are used. However, the present disclosure is not limited thereto, and three or more filters may be used. The number of filters used may be predetermined, and the combination ratio may vary depending on the number of filters. Hereinafter, signaling method regarding a method for using a CCCM filter will be described.

Method 1: There may be a method for using only one CCCM filter to obtain a chroma prediction block and a method for combining and using two predetermined filters to obtain a chroma prediction block. In this case, there may be signaling about whether only one CCCM filter is used.

Method 2: Only two predetermined filters may be used to obtain a chroma prediction block. In this case, separate signaling about the two filters may not be required.

Method 3: There may be a method for using only one CCCM filter to obtain a chroma prediction block and a method for using multiple combinations of two predetermined filters. In this case, there may be signaling as to whether only one CCCM filter is used. In addition, information about which of the multiple combinations of the two predetermined filters should be used may also be signaled.

Method 4: Multiple predetermined filter combinations may be used to obtain a chroma prediction block. Information about which filter combinations are to be used may be signaled.

Furthermore, the video signal processing device may combine a sample predicted by a CCCM with a sample predicted by a GLM to obtain a final predicted sample. The video signal processing device may combine a CCCM and a CCLM to obtain a final predicted sample. The video signal processing device may combine a CCLM and a GLM to obtain a final predicted sample. The video signal processing device may combine at least one of the CCCM, the GLM, and the CCLM with any one of intra-prediction modes to obtain a final predicted sample. In this case, the intra-prediction mode may be a chroma DM mode, an intra-prediction mode corresponding to any one of indices 0, 1, 18, and 50, or an intra-prediction mode corresponding to any one of indices 0, 1, 18, 50, and 66. When multiple methods (CCCM, GLM, CCLM, intra-prediction mode, etc.) are combined to predict a final predicted sample, each method may be combined in a predetermined combination ratio. Alternatively, the combining ratio may vary depending on whether the CCCM or the GLM is applied to the neighboring blocks of a current block.

MTS, LFNST, or various types of transformation may be applied to a chroma component block to which the CCCM or the GLM has been applied. For the transformation of a chroma component block to which the CCCM or the GLM has been applied, a predetermined MTS kernel, a predetermined LFNST kernel, or the like may be used, or any one kernel in a predetermined MTS kernel set may be determined and used based on cost. Furthermore, when LFNST is used for a chroma component block to which the CCCM or the GLM has been applied, any one kernel in the predetermined kernel set may be used for the transformation of the chroma component block to which the CCCM or the GLM has been applied. An adaptive MTS set or LFNST transformation set may be derived and used for the transformation of the chroma component block to which the CCCM or the GLM has been applied, or based on the prediction mode of the chroma component block or the prediction mode of a luma component block corresponding to the chroma component block.

The method for determining (deriving) a filter to be used from among multiple CCCM filters based on a derived intra-prediction mode may be performed adaptively on a block-by-block basis. An encoder may signal information about whether the method for deriving a filter to be used from among the multiple CCCM filters based on a derived intra-prediction mode is used for prediction of a current block. A decoder may parse the information to determine a CCCM filter to be used. If, in the decoder, the method for deriving a filter to be used from among the multiple CCCM filters based on the derived intra-prediction mode is not used for prediction of the current block, the decoder may determine a CCCM filter for prediction of the current block by parsing information indicating which CCCM filter was used.

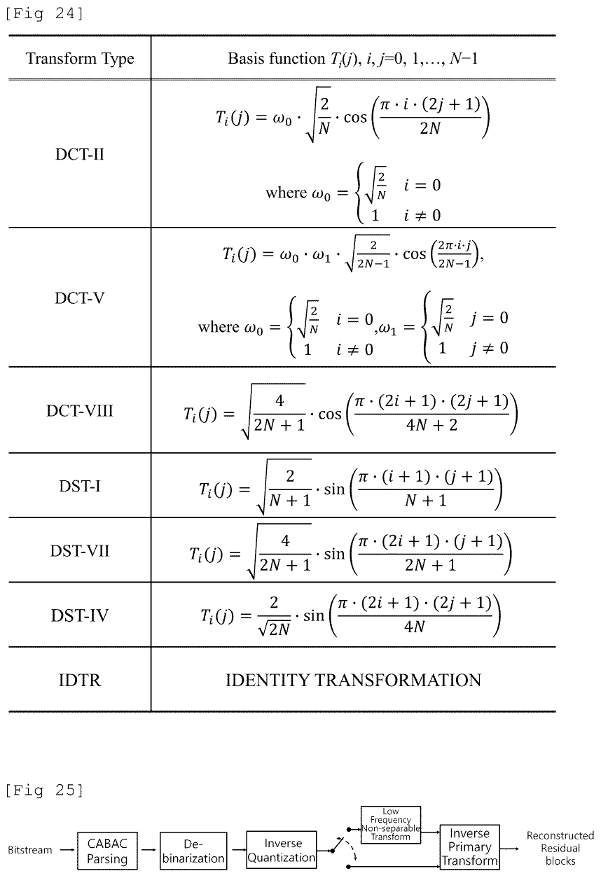

FIG. 24 illustrates the type of transform kernel according to an embodiment of the present disclosure.

Since a residual signal, which is the difference between an original signal and a predicted signal generated through inter prediction or intra prediction, has energy distributed throughout the entire pixel domain, coding the pixel values of the residual signal results in reduced compression efficiency. Therefore, it is necessary to concentrate the energy in the low-frequency area of the frequency domain through transform coding of the residual signal in the pixel domain.

In the high efficiency video coding (HEVC) standard, a residual signal in the pixel domain is transformed into the frequency domain by mostly using the discrete cosine transform type-II (DCT-II), which is efficient when the signal is evenly distributed in the pixel domain (neighboring pixel values are similar), and restrictively using the discrete sine transform type-VII (DST-VII) only for intra-predicted 4×4 blocks. The DCT-II transform may be suitable for a residual signal generated by inter prediction (the case in which energy is evenly distributed in the pixel domain). However, in the case of a residual signal generated by intra-picture prediction, due to the nature of intra prediction which uses a reconstructed reference sample around a current encoding unit, the energy of the residual signal tends to increase as a distance from the reference sample increases, so high coding efficiency may not be achieved using only the DCT-II transform.

Multiple transform selection (MTS) is a transform technique that adaptively selects a transform kernel from among multiple predetermined transform kernels depending on a prediction method, and since the pattern in the pixel domain of a residual signal (the characteristic of a signal in the horizontal direction or the characteristic of a signal in the vertical direction) varies depending on which prediction method is used, higher coding efficiency may be expected than when simply using DCT-II. FIG. 24 illustrates the definition of transform kernels used in MTS, and shows equations of the DCT-II, discrete cosine transform type-V (DCT-V), discrete cosine transform type-VIII (DCT-VIII), discrete sine transform type-I (DST-I), and DST-VII kernels applied to MTS. DCT and DST may be expressed as a cosine function and a sine function, respectively. When the basis function of a transform kernel for the number of samples N is expressed as Ti (j), the index i represents an index in the frequency domain, and the index j represents an index in the basis function. That is, as i decreases, Ti (j) represents a low-frequency basis function, while as i increases, Ti (j) represents a high-frequency basis function. The basis function Ti (j), when expressed as a two-dimensional matrix, may represent a j-th element of an i-th row, and the transform kernels shown in FIG. 24 all have the characteristics of being separable, so that the transformation may be performed on a residual signal X in each of the horizontal direction and the vertical direction. That is, when a residual signal block is called X and a transform kernel matrix is called T, the transformation on the residual signal X may be represented by TXT′. Here, T′ indicates the transpose of the transform kernel matrix T.

Since DCT and DST are in a decimal form rather than an integer form, it would be burdensome to implement DCT and DST directly in hardware encoders and decoders. Therefore, a transform kernel in the decimal form must be approximated to a transform kernel in the integer form through scaling and rounding. The integer precision of a transform kernel may be determined to be 8-bit or 10-bit, but if the precision is reduced, the coding efficiency may decrease. Depending on the approximation, the orthonormal properties of DCT and DST may not be maintained, but the loss of coding efficiency is not significant, so it is advantageous to approximate the transform kernel to an integer form in terms of implementing hardware encoders and decoders.

The identity transform (IDTR) is a transform whose result is identical to an input before the transform, and is called an identity formation. In general, the identity transformation may use a transformation matrix with “1” that is set at locations where rows and columns have the same value. However, in this case, the identity transformation is used to equally increase or decrease the value of an input residual signal by any fixed value, rather than the value of “1”.

FIG. 25 illustrates a process of reconstructing a residual signal according to an embodiment of the present disclosure.

Since a residual signal, which is the difference between an original signal and a predicted signal, is characterized in that the energy distribution of the signal varies depending on the prediction method, the coding efficiency may be improved when a transform kernel is adaptively selected according to the prediction method, such as MTS. In addition, when a transform using only an MTS or DCT-II kernel is referred to as a primary transform, a video signal processing device may also perform a secondary transform (low-frequency non-separable transform (LFNST)) on a primary transformed coefficient block to improve the coding efficiency. The secondary transform may be particularly efficient in terms of energy compaction for an intra-predicted residual signal block where strong energy is likely to be present in a direction other than the horizontal or vertical direction of the residual signal block. FIG. 25 is a block diagram illustrating a process for reconstructing a residual signal in a decoder which performs a secondary transform. First, the video signal processing device parses a syntax element related to a residual signal from a bitstream and reconstructs a quantization coefficient via de-binarization. The video signal processing device may perform dequantization on the reconstructed quantization coefficient to obtain a transform coefficient, and may perform an inverse transform on the transform coefficient to reconstruct the residual signal block. The inverse transform may be applied to a block to which transform skip (TS) is not applied, and the inverse transform may be performed in the decoder in the order of secondary inverse transform and primary inverse transform. In this case, the second inverse transform may be skipped, and the condition under which the second inverse transform may be skipped may be an inter-predicted block. Alternatively, the second inverse transform may be skipped based on a block size condition. The reconstructed residual signal includes a quantization error, and the second transform may reduce the quantization error by changing the energy distribution of the residual signal, compared to when only the first transform was performed.

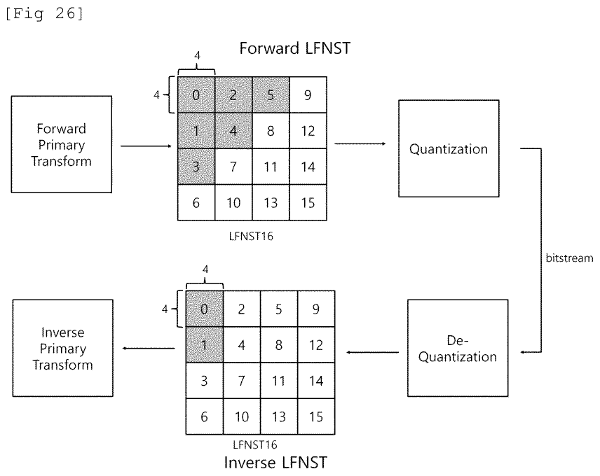

FIG. 26 illustrates a method for applying LFNST according to an embodiment of the present disclosure.

Referring to FIG. 26, an encoder may first perform a primary transform (forward primary transform) on a residual signal block to obtain a primary transformed coefficient block. When the size of the primary transformed coefficient block is M×N, the encoder may perform a 32×96 secondary transform (LFNST) on samples in the top-left ROI area of the primary transformed coefficient block with respect to an intra-predicted block in which the value of min (M, N) is 16. With respect to an intra-predicted block in which the value of Min (M, N) is 8 or greater, the encoder may perform the second transform on the samples in the top-left ROI area of the primary transformed coefficient block.

Transform coefficients of the entire transform unit size, including secondary transformed coefficients, may be quantized, and then included in a bitstream and transmitted. The bitstream may include a syntax element related to the secondary transform. Specifically, the bitstream may include information indicating a transform kernel and whether the secondary transform is applied to a current block.

A decoder may first parse quantized transform coefficients from the bitstream, and may obtain transform coefficients through dequantization. The decoder may determine whether an inverse secondary transform (inverse LFNST) is performed in the current block, based on the syntax element related to the secondary transform. When the inverse secondary transform is applied to a current transform unit, 16 or 32 transform coefficients may be the input to the inverse secondary transform, depending on the size of the transform unit, and may be equal to the number of coefficients that are output from the secondary transform by the encoder. The decoder may obtain a primary transformed coefficient through the product of a vectorized transform coefficient and an inverse secondary transform kernel matrix, wherein an inverse secondary transform kernel may be determined based on the size of the transform unit, intra mode, and a syntax element indicating a transform kernel. The inverse secondary transform kernel matrix may be the transpose of a secondary transform kernel matrix, and in consideration of the complexity of the implementation, elements of the kernel matrix may be integers represented with 10-bit or 8-bit accuracy. The primary transformed coefficient obtained by the inverse secondary transform is in a vector form, and thus may be represented again as data in a two-dimensional form, which may be dependent on intra mode. The mapping relationship based on the intra mode applied by the encoder may be applied in the same way.

A residual signal may be obtained by performing an inverse primary transform on a transform coefficient block of the entire transform unit size, which includes the transform coefficients obtained by performing the inverse secondary transform. A scaling process using a bit-shift operation may be included between the processes of the inverse secondary transform and the inverse primary transform.

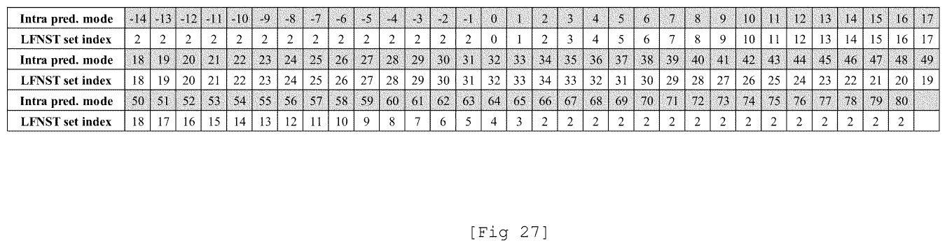

FIG. 27 illustrates a LFNST set for each intra-prediction mode according to an embodiment of the present disclosure.

The LFNST set applied to a transform block may vary depending on the intra-prediction mode. There may be multiple LFNST kernels in one set. The number of kernel candidates per LFNST set may be 4. There may be 35 LFNST sets, which may be mapped to indices from 0 to 34, respectively. The intra-prediction mode indices [−14 to −1] and [67 to 80], corresponding to a wideAngle mode, may be mapped to LFNST set index 2.

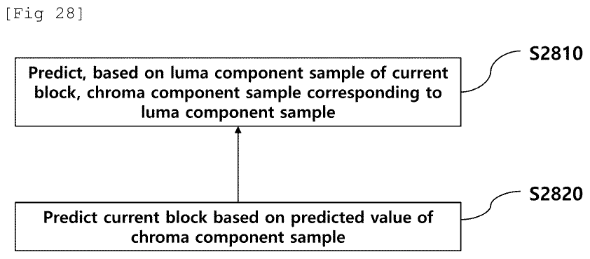

FIG. 28 illustrates a method for obtaining a predicted value of a chroma sample according to an embodiment of the present disclosure.

FIG. 28 illustrates a method for predicting a chroma sample corresponding to a luma sample through the luma samples described with reference to FIGS. 1 to 27, and reconstructing a current block by using the predicted chroma sample.

Referring to FIG. 28, a video signal processing device may predict, based on a luma component sample of a current block, a chroma component sample corresponding to the luma component sample (S2810). The video signal processing device may predict the current block based on a predicted value of the chroma component sample (S2820). The predicted value of the chroma component sample may be obtained using a linear equation. The linear equation may include a term for a gradient value of the luma component sample.

The linear equation may include a term for a value of the luma component sample.

The linear equation may include a term for a value of a filter of a Sobel-based gradient pattern. The linear equation may include a non-linear term. The linear equation may include seven terms. The linear equation may include a term for a median value of bitDepth. The linear equation may include terms for values of neighboring luma component samples of the luma component sample. In this case, the term for the values of the neighboring luma component samples may be obtained based on the filter of the Sobel-based gradient pattern.

The neighboring luma component samples may be samples of the patterns described with reference to FIGS. 19 and 20. The neighboring luma component samples may include a luma component sample adjacent to the top of the luma component sample, a luma component sample adjacent to the left of the luma component sample, a luma component sample adjacent to the right of the luma component sample, and a luma component sample adjacent to the bottom of the luma component sample. The neighboring luma component samples may include a luma component sample adjacent to the left of the luma component sample and a luma component sample adjacent to the right of the luma component sample. The neighboring luma component samples may include a luma component sample adjacent to the top of the luma component sample and a luma component sample adjacent to the bottom of the luma component sample. The neighboring luma component samples may include a luma component sample adjacent to the top-left of the luma component sample and a luma component sample adjacent to the bottom-right of the luma component sample. The neighboring luma component samples may include a luma component sample adjacent to the top-right of the luma component sample and a luma component sample adjacent to the bottom-left of the luma component sample. The neighboring luma component samples may include a luma component sample adjacent to the top-left of the luma component sample, a luma component sample adjacent to the top-right of the luma component sample, a luma component sample adjacent to the bottom-left of the luma component sample, and a luma component sample adjacent to the bottom-right of the luma component sample.

The above methods described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1-20. (canceled)

21. A video signal decoding device comprising a processor,
wherein the processor is configured to:
predict, based on a luma component sample of a current block, a chroma component sample corresponding to the luma component sample,
predict the current block based on a predicted value of the chroma component sample, and
wherein the predicted value of the chroma component sample is obtained based on an equation using CCCM (Convolutional cross-component intra prediction model).

22. The decoding device of claim 21, wherein the equation comprises a term for a gradient value of the luma component sample.

23. The decoding device of claim 21, wherein the term for the gradient value is determined based on neighboring samples, the neighboring samples are determined based on a center sample of the current block.

24. The decoding device of claim 23, wherein locations of the neighboring samples and weights of each of the neighboring samples are determined based on a preconfigured pattern.

25. The decoding device of claim 24, wherein the locations of the neighboring samples are top (N), top-left (NW), top-right (NE), bottom(S), bottom-left (SW), bottom-right (SE),
wherein a weight of the top is 2, a weight of the top-left is 1, a weight of the top-right is 1, a weight of the bottom is −2, a weight of the bottom-left is −1, a weight of the bottom-right is −1.

26. The decoding device of claim 21, wherein the equation comprises a term for a median value of bitDepth.

27. The decoding device of claim 21, wherein the equation includes a non-linear term.

28. The decoding device of claim 21, wherein the equation includes the CCCM and a non-linear mode.

29. The decoding device of claim 28, wherein the non-linear mode is at least one of a chroma DM mode and/or an intra prediction mode.

30. A video signal encoding device comprising a processor,
wherein the processor is configured to obtain a bitstream that is decoded by a decoding method,
wherein the decoding method comprises:
predicting, based on a luma component sample of a current block, a chroma component sample corresponding to the luma component sample; and
predicting the current block based on a predicted value of the chroma component sample,
wherein the predicted value of the chroma component sample is obtained based on an equation using CCCM (Convolutional cross-component intra prediction model).

31. The encoding device of claim 30, wherein the equation comprises a term for a gradient value of the luma component sample.

32. The encoding device of claim 30, wherein the term for the gradient value is determined based on neighboring samples, the neighboring samples are determined based on a center sample of the current block.

33. The encoding device of claim 32, wherein locations of the neighboring samples and weights of each of the neighboring samples are determined based on a preconfigured pattern.

34. The encoding device of claim 33, wherein the locations of the neighboring samples are top (N), top-left (NW), top-right (NE), bottom(S), bottom-left (SW), bottom-right (SE),
wherein a weight of the top is 2, a weight of the top-left is 1, a weight of the top-right is 1, a weight of the bottom is −2, a weight of the bottom-left is −1, a weight of the bottom-right is −1.

35. The encoding device of claim 30, wherein the equation comprises a term for a median value of bitDepth.

36. The encoding device of claim 30, wherein the equation includes a non-linear term.

37. The decoding device of claim 30, wherein the equation includes the CCCM and a non-linear mode.

38. The decoding device of claim 37, wherein the non-linear mode is at least one of a chroma DM mode and/or an intra prediction mode.

39. A computer-readable non-transitory storage medium for storing a bitstream, wherein the bitstream is decoded by a decoding method,
wherein the decoding method comprises:
predicting, based on a luma component sample of a current block, a chroma component sample corresponding to the luma component sample; and
predicting the current block based on a predicted value of the chroma component sample,
wherein the predicted value of the chroma component sample is obtained based on an equation using CCCM (Convolutional cross-component intra prediction model).

40. The encoding device of claim 30, wherein the equation comprises a term for a gradient value of the luma component sample.
